(19) United States
(12) Patent Application Publication
(10) Pub. No.: US 2009/0198770 A1
(43) Pub. Date: Aug. 6, 2009

(54) SYSTEM AND METHOD OF UPDATING CODES IN CONTROLLER

(75) Inventor: Yeshang Jiang, Kunming (CN)

Correspondence Address: AUSTIN RAPP & HARDMAN, 170 South Main Street, Suite 735, SALT LAKE CITY, UT, 84101, US

(73) Assignee: Universal Scientific Industrial Co., Ltd., Caotun Township (TW)

(21) Appl. No.: 12/025,452

(22) Filed: Feb. 4, 2008

(51) Int. Cl. G06F 15/16

(52) U.S. Cl. 709/203

(57) ABSTRACT

A system and method of updating codes stored in a controller based on the two-channel protocol standard are described. The updating system includes an application program unit, a kernel buffer, and a general purpose input/output control module. The application program unit receives the updating command and the code file via the network. The kernel buffer downloads the code file based on the updating command from the application program unit and stores the code file into the kernel buffer. The two-channel control module reads the code file stored in the kernel buffer and converts the code file into a clock signal and a data signal. The general purpose input/output control module has a clock channel and a data channel for receiving the clock signal and the data signal and transmitting the clock signal and the data signal via the clock channel and the data channel, respectively, to the controller of the network storage apparatus for updating the original codes in the controller.

### FIELD OF THE INVENTION

The present invention relates to a system of updating codes and method thereof, and more particularly, to a system and method of updating the codes which are stored in a controller based on the two-channel protocol standard, whereby an updating command is remotely executed via a network and the updating system is capable of receiving a code file remotely for updating the codes originally stored in the controller according to the updating command.

### BACKGROUND OF THE INVENTION

With the maturity of information system technologies and rapid development of the network communication, an information system is widely utilized to access information via the network. For example, the client computer accesses the data shared by the storage facility, such as a network attached storage (NAS), on the network. However, it is required to modify the original codes in the network storage for more application fields. In other words, the codes in the controller of the network storage need to be replaced with new codes. In another case, while the codes stored in the controller have to be debugged, it is necessary to read the codes in the network storage via the joint test action group (JTAG) connection, thereby resulting in inconvenient updating operation.

Generally speaking, during the manufacturing process of the network storage, it is required to design a JTAG connection port for the development circuit of the network storage, so that the controller of the network storage can be updated, and thereby resulting in frequent occupation of the development circuit. In addition, the manufacturer repeatedly debugs the codes in the controller and the correct codes are finally written into the controller; thus, the manufacturer has to prepare the dedicated writing device for writing the correct codes and by doing so takes a lot of time and cost. Moreover, after the user purchases the network storage, the manufacturer has to send the code file and writing tools to the user for service and the user should learn to operate the writing tools and adjust the writing parameters; therefore, it is proven to be quite inconvenient. Additionally, while the user desires to update the codes in the controller, the user needs to disassembly the network storage while the JTAG connection is enclosed in the network storage. This would be quite unfavorable. Consequentially, there is a need to develop a novel updating system and method thereof to solve the aforementioned problems.

### SUMMARY OF THE INVENTION

The first objective of the present invention is to provide a system and method of updating the codes based on the two-channel protocol standard to improve the conventional JTAG connection. Further, the two input/output ports of the updating system based on the two-channel protocol standard are utilized to simulate the clock channel and the data channel, for writing a code file to the non-volatile memory.

The second objective of the present invention is to provide a system and method of updating the codes based on the two-channel protocol standard so that the user is capable of selecting the desired code file and writing the selected code file based on the two-channel protocol standard for the code file sent by the manufacture; therefore, the manufacture can avoid having to provide the writing tools and writing parameter adjustment for the user, thus solves the above-mentioned problems.

The third objective of the present invention is to provide a system and method of updating the codes based on the two-channel protocol standard so that the user is capable of selecting the desired code file and writing the selected code file based on the two-channel protocol standard to avoid the disassembly of the network storage while updating the original codes.

According to the above objectives, the present invention sets forth a system and method of updating the codes which are stored in a controller based on the two-channel protocol standard. The updating system includes a processing unit and a controller. The processing unit couples to the controller via the clock channel and a data channel. The processing unit has an application program unit, a kernel buffer, a two-channel control module, and a general purpose input/output (GPIO) control module. The application program unit receives the updating command and the code file via the network. The kernel buffer downloads the code file based on the updating command from the application program unit and stores the code file into the kernel buffer. The two-channel control module reads the code file stored in the kernel buffer and converts the code file into a clock signal and a data signal. The general purpose input/output (GPIO) control module has a clock channel and a data channel for receiving the clock signal and the data signal and transmitting the clock signal and the data signal via the clock channel and the data channel, respectively, to the controller of the network storage apparatus for updating the original codes in the controller.

The application program unit further includes a network interface module and an input/output control module. The network interface module is coupled to the network and the input/output control module couples the network interface module to the two-channel control module. The network interface module communicates with the client computer via the network for receiving the updating command and the code file. The input/output control module transmits the updating command to the two-channel control module.

The controller further includes a two-channel protocol module, a programming unit, and a non-volatile memory. The two-channel protocol module receives the clock signal and the data signal from the clock channel and the data channel, respectively. The programming unit has a control register and a data register for writing the updating command and the code file to the control register and the data register, respectively. The non-volatile memory has the original codes and the application program unit writes the code file to the non-volatile memory for replacing the original codes with the code file based on the updating command.

According to the above-mentioned descriptions, the two-channel control module of the updating system is electrically coupled to the controller having a two-channel protocol module via the general purpose input/output (GPIO) control module. On the basis of the clock channel and the data channel, the controller programs the non-volatile memory for replacing the original codes within the controller. That is, the two input/output ports of the updating system are utilized to simulate the clock channel and the data channel, respectively. For example, the general purpose input/output (GPIO) control module of the processing unit simulates the two-channel protocol interface so that the processing unit receives/transmits the addresses and data from/to the controller.

The method of updating the codes stored in a controller includes the following steps of:

(a) The updating system and the two-channel control module are initialized.

(b) The controller is activated by a network identification number so that the client computer communicates with the updating system to be a control mode.

(c) The application program unit receives a code file from the server computer and an updating command from the client computer via the network.

(d) The application program unit selects a control mode according to the updating command, and the control mode includes a writing mode, an erasing mode, and a correction mode.

(d1) The two-channel control module writes the code file to the non-volatile memory of the controller based on the updating command. That is, while the updating system receives the updating command during the writing mode, a clock signal is transmitted to a controller of the updating system via a clock channel and the code file is simultaneously transmitted to the controller via a data channel based on the clock signal for updating the original codes in the controller.

(d2) The two-channel control module erases the original codes in the non-volatile memory of the controller based on the updating command.

(d3) The two-channel control module calculates a checksum value of the code file in the non-volatile memory of the controller based on the updating command for checking the correction of the code file. If the code file is incorrect, the two-channel protocol module resets the clock signal of the clock channel.

(e) The updating system returns the operation information of control modes and the result associated with the control modes back to the client computer.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic diagram of a system for updating the codes stored in a controller according to one embodiment of the present invention;

FIG. 2 is a detailed schematic diagram of a system for updating the codes stored in a controller shown in FIG. 1 according to one embodiment of the present invention;

FIG. 3A is a schematic diagram of a type module of the two-channel control module shown in FIG. 2 according to one embodiment of the present invention;

FIG. 3B is a schematic diagram of a register unit of the two-channel control module shown in FIG. 2 according to one embodiment of the present invention;

FIG. 4 is a detailed schematic diagram of the controller shown in FIG. 2 according to one embodiment of the present invention;

FIGS. 5A-5D illustrate read/write timing waveform diagrams of simulating the two-channel protocol standard by the general purpose input/output (GPIO) control module according to one embodiment of the present invention; and

FIG. 6 is a flow chart of performing the updating method of the codes stored in the controller according to one embodiment of the present invention.

### DETAILED DESCRIPTION OF THE PREFERRED EMBODIMENTS

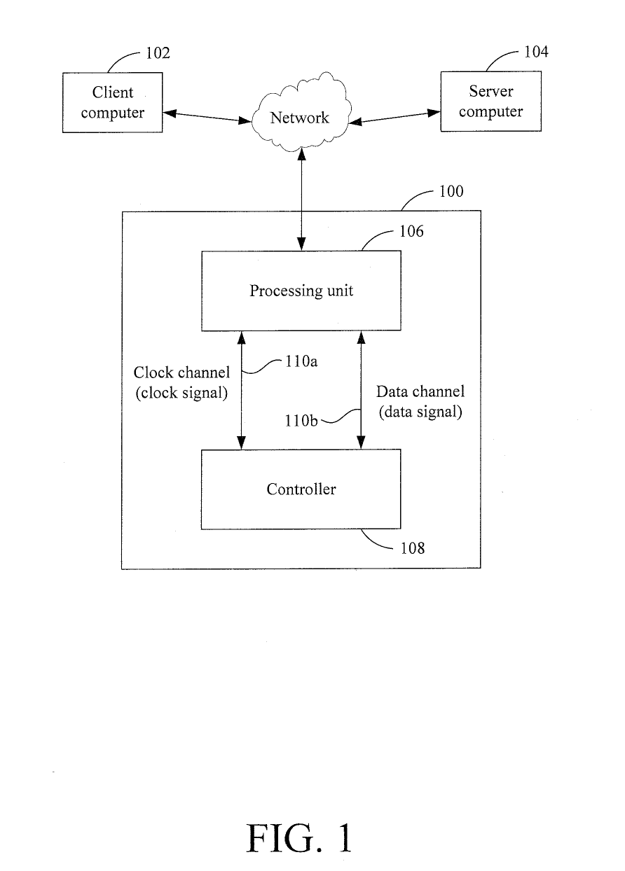

FIG. 1 is a schematic diagram of a system 100 for updating the codes stored in a controller 108 according to one embodiment of the present invention. The updating system 100 is coupled to, respectively, a client computer 102 and a server computer 104 via the network. The updating system 100 includes a processing unit 106 and a controller 108. While updating the controller 108, the client computer 102 selects a code file stored in the server computer 104 via the network and issues an updating command to the updating system 100. The processing unit 106 of the updating system 100 downloads the code file based on the updating command and updates the original codes stored in the controller 108 with the code file via the two-channel channel protocol standard; the code file, for example, is a writable file content. The two-channel channel protocol standard has a clock channel 110a and a data channel 100b for transmitting a clock signal and a data signal corresponding to the code file to update the original codes in the controller 108. In one embodiment, the clock channel 100a of the two-channel protocol standard of the controller 108 is coupled to one general input/output port of the processing unit 106 and the data channel 110b of the two-channel protocol standard of the controller 108 is coupled to one general input/output port of the processing unit 106. The system 100 for updating the codes stored in a controller 108 is applicable a network storage, such as a network attached storage (NAS). In one embodiment, the processing unit 106 is series “CPU-8313E processor and the controller 108 is series “8051” of control chips or the like. Preferably, the controller 108 is compatible to the single control chip having the two-channel protocol standard. The updating system 100 will be described in detail below.

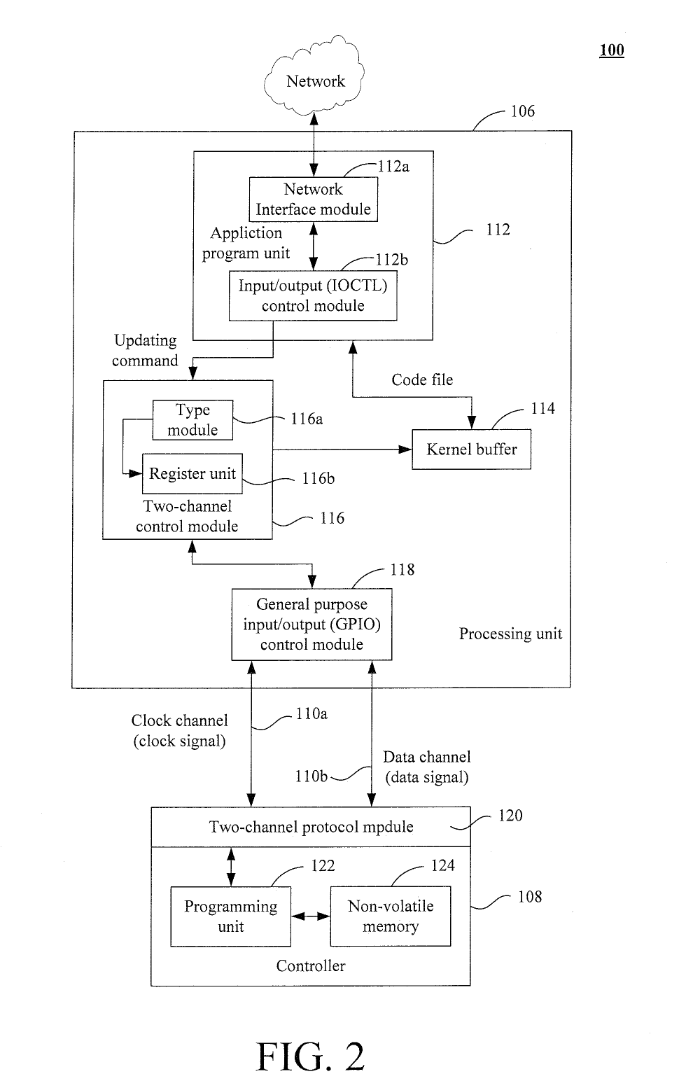

FIG. 2 is a detailed schematic diagram of a system 100 for updating the codes stored in a controller shown in FIG. 1 according to one embodiment of the present invention. The updating system 100 includes a processing unit 106 and a controller 108. The processing unit 106 couples to the controller 108 via the clock channel 110a and a data channel 110b. The processing unit 106 has an application program unit 112, a kernel buffer 114, a two-channel control module 116, and a general purpose input/output (GPIO) control module 118. The application program unit 112 is coupled to the client computer 102 and a server computer 104 via the network. The application program unit 112 is coupled to the kernel buffer 114 and the two-channel control module 116. The two-channel control module 116 is coupled to the kernel buffer 114 and the general purpose input/output (GPIO) control module 118. The general purpose input/output (GPIO) control module 118 is coupled to the controller 108. For example, the network may be constructed by wire, such as cable, or wireless, such as a bluetooth technique. Further, the network may be wide area network (WAN), such as Internet, and/or local area network (LAN), such as Intranet or Ethernet.

The application program unit 112 receives the updating command and the code file via the network. The kernel buffer 114 download the code file based on the updating command from the application program unit 112 and stores the code file into the kernel buffer 114. The two-channel control module 116 reads the code file stored in the kernel buffer 114 and converts the code file into a clock signal and a data signal. The general purpose input/output (GPIO) control module 118 has a clock channel and a data channel for receiving the clock signal and the data signal and transmitting the clock signal and the data signal via the clock channel and the data channel, respectively, to the controller 108 of the network storage apparatus for updating the original codes in the controller 108.

The application program unit 112 further includes a network interface module 112a and an input/output control module 112b. The network interface module 112a is coupled to the network and the input/output control module 112b couples the network interface module 112a to the two-channel control module 116. The network interface module 112a communicates with the client computer 102 and the client computer 104 via the network for receiving the updating command and the code file. The input/output control module 112b transmits the updating command to the two-channel control module 116.

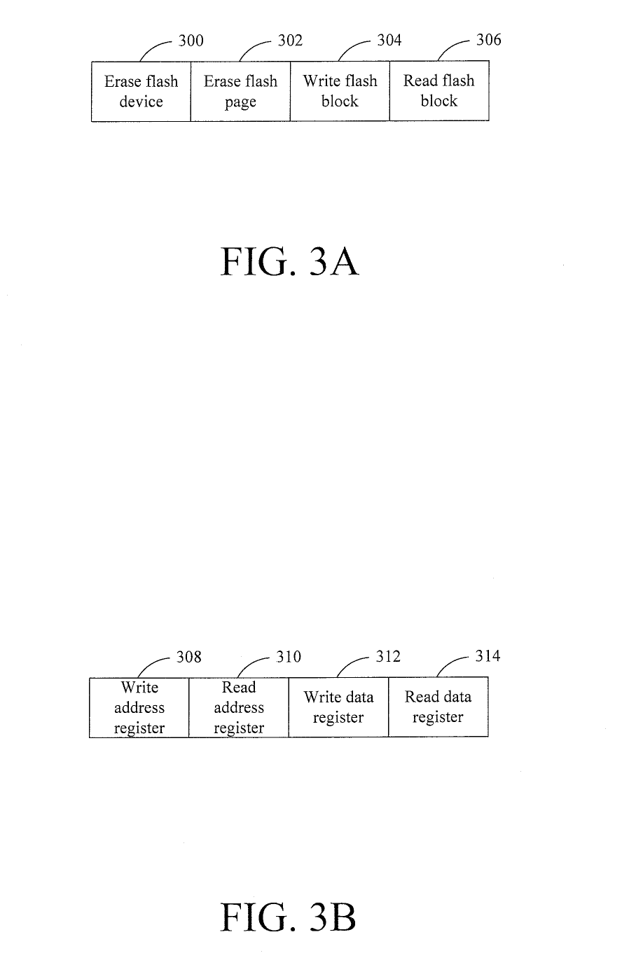

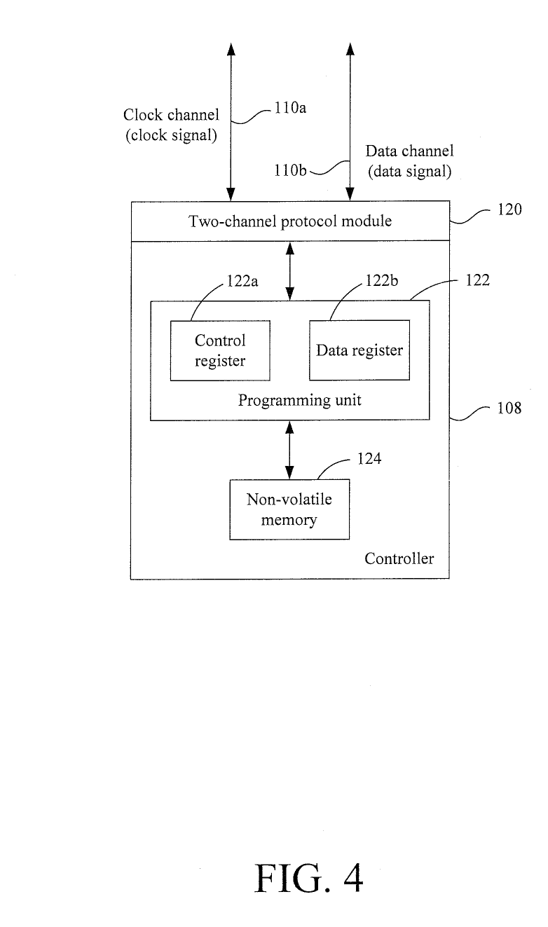

The two-channel control module 116 further includes a type module 116a and a register unit 116b. Please refer to FIG. 1, and FIGS. 3a-3B. FIG. 3A is a schematic diagram of a type module 116a of the two-channel control module 116 shown in FIG. 2 according to one embodiment of the present invention. FIG. 3B is a schematic diagram of a register unit 116b of the two-channel control module 116 shown in FIG. 2 according to one embodiment of the present invention.

In FIG. 3A, the type module 116a is coupled to the input/output control module 112b and stores a control type of the controller 108 for managing the control statuses of the non-volatile memory. The control type of the controller 108 is selected from one group consisting of an erasing flash device 300, an erasing flash page 302, a writing flash block 304, a reading flash block 306, or the combinations thereof. When the updating status of the updating system 100, according to the updating command, is the status of erasing the controller 108, the type of erasing flash device 300 is allocated by the updating system 100. When the updating status of the updating system 100, according to the updating command, is the status of erasing page of the controller 108, the type of erasing flash page 302 is allocated by the updating system 100. When the updating status of the updating system 100, according to the updating command, is the status of writing block of the controller 108, the type of writing flash block 304 is allocated by the updating system 100. When the updating status of the updating system 100, according to the updating command, is the status of reading block of the controller 108, the type of reading flash block 304 is allocated by the updating system 100.

In FIG. 3B, the register unit 116b is coupled to the type module and has a plurality of registers for reading the code file from the kernel buffer 114 on the basis of the updating command and stores the code file into the registers. The registers of the register unit 116b is selected from one group consisting of a writing address register 308, a reading address register 310, a writing data register 312, a reading data register 314, or the combinations thereof. The two-channel control module 116 analyzes the code file stored in the kernel buffer 114. Further, the address information to be written to the controller 108 is stored in writing address register 308, the address information to be read by the controller 108 is stored in the reading address register 310, the data to be written to the controller 108 is stored in the writing data register 312, and the data to be read by the controller 108 is stored in the reading data register 314.

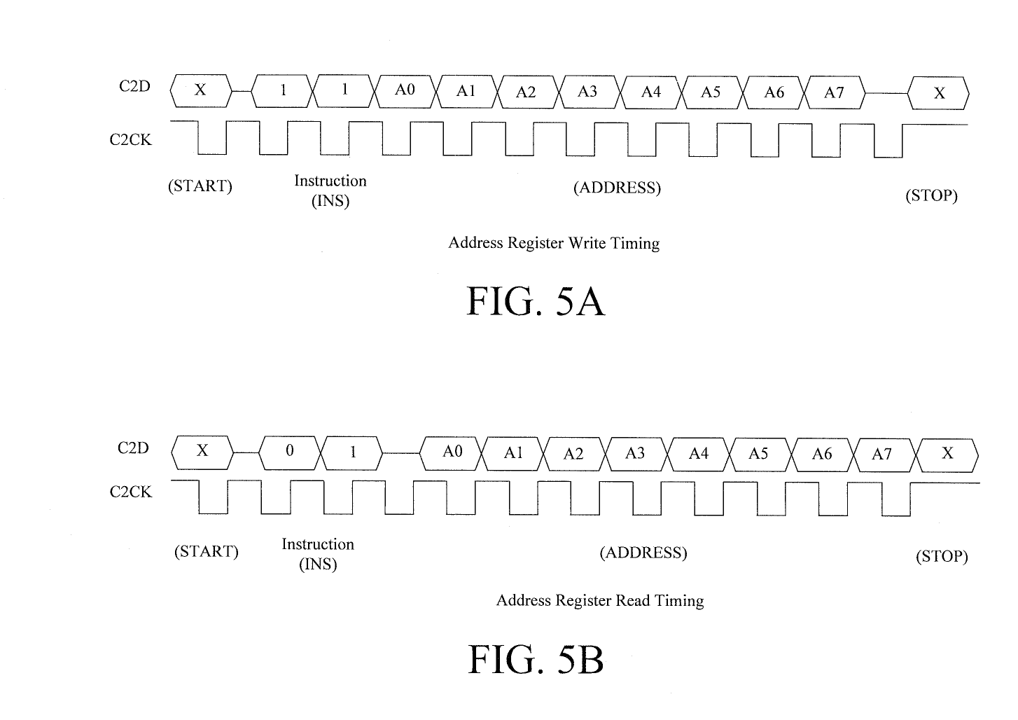

The controller 108 further includes a two-channel protocol module 120, a programming unit 122, and a non-volatile memory 124. The two-channel protocol module 120 couples the general purpose input/output (GPIO) control module 118 to the programming unit 122, and the programming unit 122 is coupled to the non-volatile memory 124. The two-channel protocol module 120 receives the clock signal and the data signal from the clock channel 110a and the data channel 110b, respectively FIG. 4 is a detailed schematic diagram of the controller 108 shown in FIG. 2 according to one embodiment of the present invention. As shown in FIG. 4, the programming unit 122 has a control register 122a and a data register 122b for writing the updating command and the code file to the control register 122a and the data register 122b, respectively. The non-volatile memory 124 has the original codes and the application program unit 122 writes the code file to the non-volatile memory 124 for replacing the original codes with the code file based on the updating command; the non-volatile memory 124, for example, is flash memory.

In one embodiment, the programming unit 122 further erases the original codes in the non-volatile memory 124 based on the updating command in the control register 122a. The programming unit 122 further calculates a checksum value of the code file in the non-volatile memory 124 based on the updating command in the control register 122a for checking the correction of the code file.

According to the above-mentioned descriptions, the two-channel control module 116 of the updating system 100 is electrically coupled to the controller 108 having a two-channel protocol module 120 via the general purpose input/output (GPIO) control module 118. On the basis of the clock channel 110a and the data channel 110b, the controller 108 programs the non-volatile memory 124 for replacing the original codes within the controller 108. That is, the two input/output ports of the updating system 100 are utilized to simulate the clock channel 110a and the data channel 110b, respectively. For example, the general purpose input/output (GPIO) control module 118 of the processing unit 106 simulates the two-channel protocol interface so that the processing unit 106 receives/transmits the addresses and data from/to the controller 108.

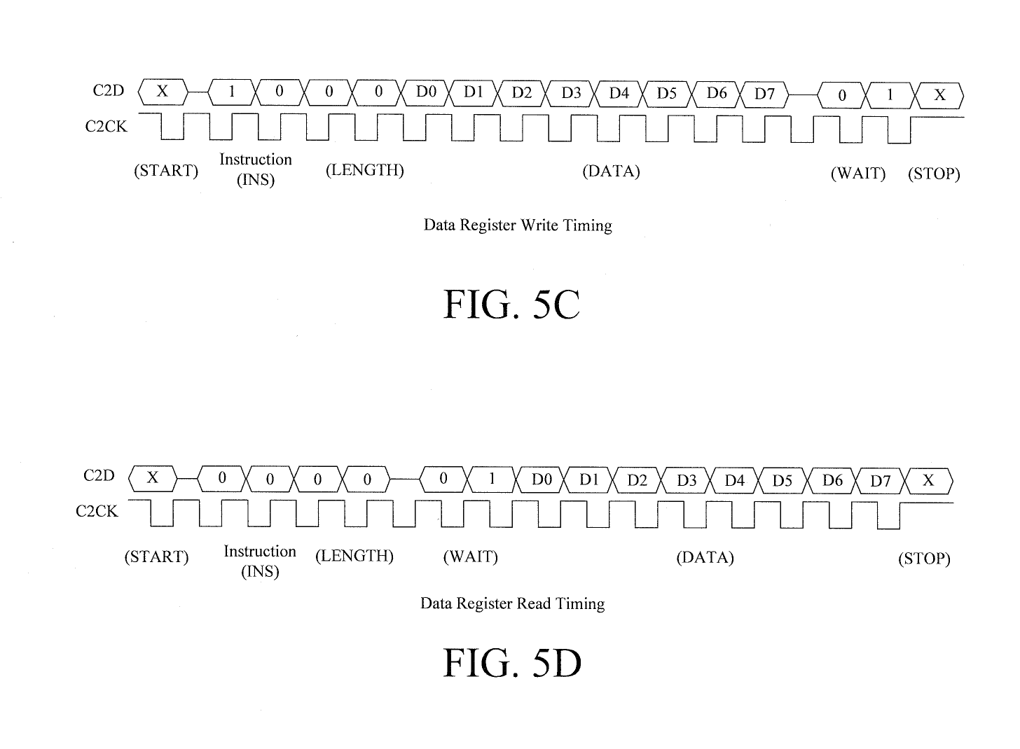

FIGS. 5A-5D illustrate read/write timing waveform diagrams of simulating the two-channel protocol standard by the general purpose input/output (GPIO) control module 118 according to one embodiment of the present invention. According to the two-channel protocol standard, the two-channel control module 116 controls the general purpose input/output (GPIO) control module 118 for outputting the clock signal “C2CK” and the data signal “C2D” via the clock channel 110a and the data channel 110b.

FIG. 5A shows a writing timing waveform of an address register. According to the clock signal “C2CK”, the time interval of the data signal “C2D” is interval “START”, instruction interval “INS”, interval “ADDRESS”, and interval “STOP” sequentially. In one embodiment, data channel 110b is disabled first. Then, the clock signal of clock channel 110a in the two-channel protocol module 120 is started and the interval is assigned to be ten (time unit). Afterwards, the data channel 110b is set as high level and the data channel 110b is enabled. The clock signal of the two-channel protocol module 120 is started and the interval is assigned to be thirty (time unit). Again, the data channel 110b is set as high level and the clock signal of the two-channel protocol module 120 is started and the interval is assigned to be thirty (time unit). Then, the address which written to the address register is transmitted to the programming unit 122 via the general purpose input/output (GPIO) control module 118. Finally, the data channel 110b is disabled, the clock signal of the two-channel protocol module 120 is started, and the operation of the two-channel is terminated during the interval “STOP”.

FIG. 5B shows a reading timing waveform of an address register. According to the clock signal “C2CK”, the time interval of the data signal “C2D” is interval “START”, instruction interval “INS”, interval “ADDRESS”, and interval “STOP” sequentially. In one embodiment, data channel 110b is disabled first. Then, the clock signal of clock channel 110a in the two-channel protocol module 120 is started and the interval is assigned to be ten (time unit). Afterwards, the data channel 110b is set as low level and the data channel 110b is enabled. The clock signal of the two-channel protocol module 120 is started and the interval is assigned to be thirty (time unit). Again, the data channel 110b is set as high level and the clock signal of the two-channel protocol module 120 is started and the interval is assigned to be thirty (time unit). Then, the address which written to the address register is transmitted to the reading address register via the general purpose input/output (GPIO) control module 118. Finally, the data channel 110b is disabled, the clock signal of the two-channel protocol module 120 is started, and the operation of the two-channel is terminated during the interval “STOP”.

FIG. 5C shows a writing timing waveform of a data register. According to the clock signal “C2CK”, the time interval of the data signal “C2D” is interval “START”, instruction interval “INS”, data length interval “LENGTH”, interval “DATA”, interval “WAIT”, and interval “STOP” sequentially. In one embodiment, data channel 110b is disabled first. Then, the clock signal of clock channel 110a in the two-channel protocol module 120 is started and the interval is assigned to be ten (time unit). Afterwards, the data channel 110b is set as high level and the data channel 110b is enabled. The clock signal of the two-channel protocol module 120 is started and the interval is assigned to be thirty (time unit). Again, the data channel 110b is set as low level and the clock signal of the two-channel protocol module 120 is started and the interval is assigned to be thirty (time unit). Then, the data channel 110b is set as low level and the data channel 110b is enabled. The clock signal of the two-channel protocol module 120 is started and the interval is assigned to be twenty (time unit). Again, the data channel 110b is set as low level, the clock signal of the two-channel protocol module 120 is started and the interval is assigned to be twenty (time unit). Then, the address which written to the address register is transmitted to the programming unit 122 via the general purpose input/output (GPIO) control module 118. Further, the data channel 110b is in high level and then the data channel 110b is in low level. The data channel 110b is disabled and the clock signal of the two-channel protocol module 120 is started. Finally, the data channel 110b is disabled, the clock signal of the two-channel protocol module 120 is started, and the operation of the two-channel is terminated during the interval “STOP”.

FIG. 5D shows a reading timing waveform of a data register. According to the clock signal “C2CK”, the time interval of the data signal “C2D” is interval “START”, instruction interval “INS”, data length interval “LENGTH”, interval “WAIT”, interval “DATA”, and interval “STOP” sequentially. In one embodiment, data channel 110b is disabled first. Then, the clock signal of clock channel 110a in the two-channel protocol module 120 is started and the interval is assigned to be ten (time unit). Afterwards, the data channel 110b is set as low level and the data channel 110b is enabled. The clock signal of the two-channel protocol module 120 is started and the interval is assigned to be thirty (time unit), Again, the data channel 110b is set as low level and the clock signal of the two-channel protocol module 120 is started and the interval is assigned to be thirty (time unit). Then, the data channel 110b is set as low level and the data channel 110b is enabled. The clock signal of the two-channel protocol module 120 is started and the interval is assigned to be twenty (time unit), Again, the data channel 110b is set as low level, the clock signal of the two-channel protocol module 120 is started and the interval is assigned to be twenty (time unit). Then, the address which written to the address register is transmitted to the programming unit 122 via the general purpose input/output (GPIO) control module 118. Finally, the data channel 110b is disabled, the clock signal of the two-channel protocol module 120 is started, and the operation of the two-channel is terminated during the interval “STOP”.

Therefore, the updating system 100 performs a programming procedure on the non-volatile memory 124 within the controller 108 based on the two-channel protocol standard via the clock channel 110a and the data channel 110b for replacing the original codes of the non-volatile memory 124 with the code file. Further, the updating system 100 simulates the two-channel protocol interface loading a code file to the non-volatile memory 124. The updating system 100 of the present invention is applicable to arbitrary operating system of software, such as the operating system of “LINUX” or “WINDOWS”.

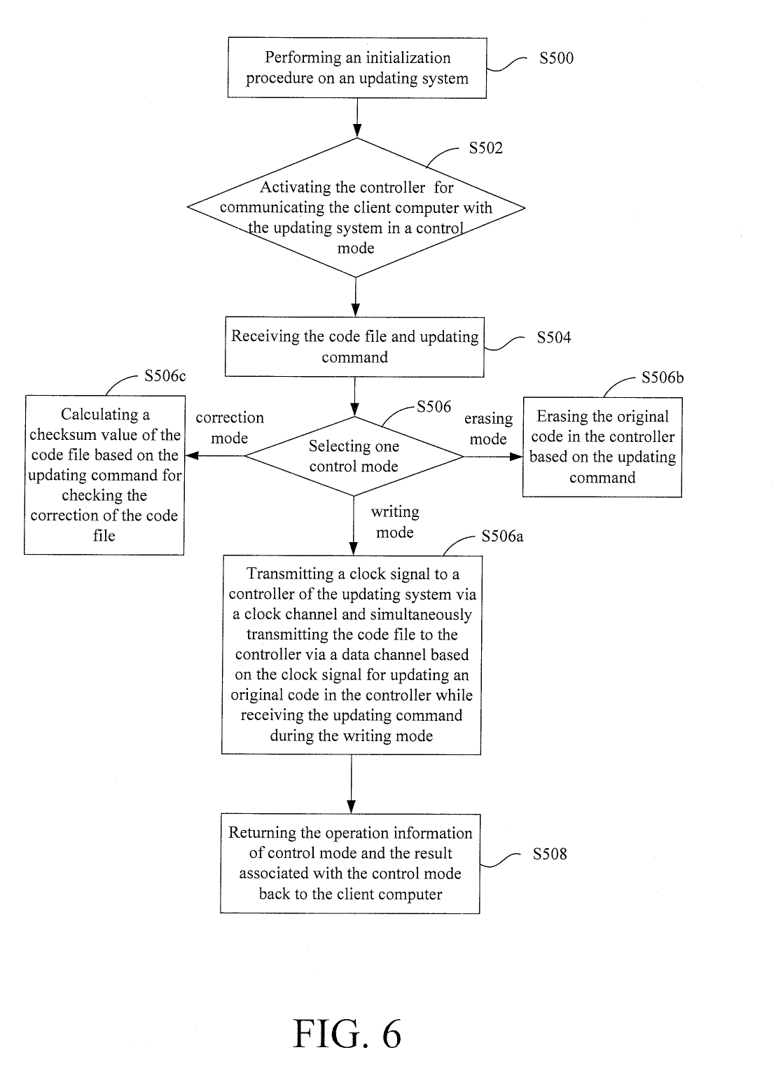

Please refer to FIGS. 1-2, and FIG. 6. FIG. 6 is a flow chart of performing the updating method of the codes stored in the controller according to one embodiment of the present invention. The method of updating the codes stored in a controller is suitable for a network storage apparatus. The network storage apparatus is coupled to a client computer 102 and a server computer 104 via a network, respectively, and the client computer 102 issues an updating command to the network storage apparatus via the network. The method includes the following steps of:

In step S500, the updating system 100 and the two-channel control module 116 are initialized.

In step S502, the controller 108 is activated by a network identification number so that the client computer 102 communicates with the updating system 100 in a control mode. If the controller 108 is inactive, the client computer 102 exits from the two-channel control module 116 of the updating system 100.

In step S504, the application program unit 112 receives a code file from the server computer 104 and an updating command from the client computer 104 via the network.

In step S506, the application program unit 112 selects a control mode according to the updating command, and the control mode includes at least one of a writing mode, an erasing mode, a correction mode, and the combinations thereof.

In step S506a of the writing mode, the two-channel control module 116 writes the code file to the non-volatile memory 124 of the controller 108 based on the updating command. That is, while the updating system receives the updating command during the writing mode, a clock signal is transmitted to a controller 108 of the updating system 100 via a clock channel and the code file is simultaneously transmitted to the controller 108 via a data channel 110b based on the clock signal for updating the original codes in the controller 108. In one embodiment, the two-channel control module 116 reads the content of the kernel buffer 114 to be putted into the register unit 116b at a batch. Then, the content in the register unit 116b is sequentially written to the non-volatile memory 124 until the content in the kernel buffer 114 is read completely. After step S506a is complete, the controller 108 is inactive and exits from the updating system 100.

In step S506b of the erasing mode, the two-channel control module 116 erases the original codes in the non-volatile memory 124 of the controller 108 based on the updating command. After step S506b is complete, the controller 108 is inactive.

In step S506c of the correction mode, the two-channel control module 116 calculates a checksum value of the code file in the non-volatile memory 124 of the controller 108 based on the updating command for checking the correction of the code file. If the code file is incorrect, the two-channel protocol module resets the clock signal of the clock channel 110a. After step S506c is complete, the controller 108 is inactive.

In step S508, the updating system 100 returns the operation information of control modes and the result associated with the control modes back to the client computer 102.

The features of the present invention includes: (a) remotely updating the original codes stored in the controller via the network; (b) serving the function of writing the code file to replace the conventional method using an external writer device of the codes to the controller; (c) solving the problems of the code file sent by the manufacture to avoid the preparation of writing tools and writing parameter adjustment for the user; and (d) utilizing the two-channel protocol standard to select the desired code file to avoid the disassembly of the network storage while updating the original codes.

As is understood by a person skilled in the alt, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A system of updating the codes stored in a controller of a network storage apparatus, wherein the network storage apparatus is coupled to a client computer and a server computer via a network, respectively, and the client computer issues an updating command to the network storage apparatus via the network so that the network storage apparatus receives a code file from the server computer based on the updating command, the system comprising:
an application program unit, for receiving the updating command and the codes file via the network;
a kernel buffer, for downloading the code file based on the updating command from the application program unit and storing the code file into the kernel buffer;
a two-channel control module, for coupling to the application program unit and the kernel buffer, respectively, reading the code file stored in the kernel buffer and converting the code file into a clock signal and a data signal; and
a general purpose input/output control module having a clock channel and a data channel, for receiving the clock signal and the data signal and transmitting the clock signal and the data signal via the clock channel and the data channel, respectively, to the controller of the network storage apparatus for updating the original codes in the controller.

2. The system of claim 1, wherein the application program unit further comprises:
a network interface module, for communicating with the client computer and the client computer via the network for receiving the updating command and the code file; and
an input/output control module, for transmitting the updating command to the two-channel control module.

3. The system of claim 2, wherein the two-channel control module further comprises:
a type module coupling to the input/output control module, for storing a control type of the controller; and
a register unit coupling to the type module and having a plurality of registers, for reading the code file from the kernel buffer on the basis of the updating command and storing the code file into the registers.

4. The system of claim 3, wherein the control type of the controller is selected from one group consisting of an erasing flash device, an erasing flash page, a writing flash block, a reading flash block, and the combinations thereof.

5. The system of claim 3, wherein the registers of the register unit is selected from one group consisting of a writing address register, a reading address register, a writing data register, a reading data register, and the combinations thereof.

6. The system of claim 3, wherein the controller further comprises:
a two-channel protocol module coupling to the general purpose input/output control module, for receiving the clock signal and the data signal from the clock channel and the data channel, respectively;
a programming unit coupling to the two-channel protocol module and having a control register and a data register, writing the updating command and the code file to the control register and the data register, respectively; and
a non-volatile memory having the original codes, allowing the application program unit to write the code file to the non-volatile memory for replacing the original codes with the code file based on the updating command.

7. The system of claim 6, wherein the programming unit further erases the original codes in the non-volatile memory based on the updating command in the control register.

8. The system of claim 6, wherein the programming unit further calculates a checksum value of the code file in the non-volatile memory based on the updating command in the control register for checking the correction of the code file.

9. The system of claim 6, wherein the two-channel protocol module resets the clock signal of the clock channel if the code file is incorrect.

10. A network storage apparatus having a system for updating the codes stored in a controller, wherein the network storage apparatus is coupled to a client computer and a server computer via a network, respectively, and the client computer issues an updating command to the network storage apparatus via the network so that the network storage apparatus receives a code file from the server computer, the network storage apparatus comprising:
an application program unit, for receiving the updating command and the codes file via the network;
a kernel buffer, for downloading the code file based on the updating command from the application program unit and storing the code file into the kernel buffer;
a two-channel control module, for coupling to the application program unit and the kernel buffer, respectively, for reading the code file stored in the kernel buffer and converting the code file into a clock signal and a data signal; and
a general purpose input/output control module having a clock channel and a data channel, for receiving the clock signal and the data signal and transmitting the clock signal and the data signal via the clock channel and the data channel, respectively, to the controller of the network storage apparatus for updating the original codes in the controller.

11. The apparatus of claim 10, wherein the application program unit further comprises:
a network interface module, for communicating with the client computer and the client computer via the network for receiving the updating command and the code file; and
an input/output control module, for transmitting the updating command to the two-channel control module.

12. The apparatus of claim 11, wherein the two-channel control module further comprises:
a type module coupled to the input/output control module, for storing a control type of the controller; and
a register unit coupled to the type module and having a plurality of registers, for reading the code file from the kernel buffer on the basis of the updating command and storing the code file into the registers.

13. The apparatus of claim 12, wherein the control type of the controller is selected from one group consisting of an erasing flash device, an erasing flash page, a writing flash block, a reading flash block, and the combinations thereof.

14. The apparatus of claim 12, wherein the registers of the register unit is selected from one group consisting of a writing address register, a reading address register, a writing data register, a reading data register, and the combinations thereof.

15. The apparatus of claim 12, wherein the controller further comprises:
a two-channel protocol module coupled to the general purpose input/output control module, for receiving the clock signal and the data signal from the clock channel and the data channel, respectively;
a programming unit coupled to the two-channel protocol module having a control register and a data register, for writing the updating command and the code file to the control register and the data register, respectively; and
a non-volatile memory having the original codes, allowing the application program unit to write the code file to the non-volatile memory for replacing the original codes with the code file based on the updating command.

16. The apparatus of claim 15, wherein the programming unit further erases the original codes in the non-volatile memory based on the updating command in the control register.

17. The apparatus of claim 15, wherein the programming unit further calculates a checksum value of the code file in the non-volatile memory based on the updating command in the control register for checking the correction of the code file.

18. A method of updating the codes stored in a controller of a network storage apparatus, wherein the network storage apparatus is coupling to a client computer and a server computer via a network, respectively, and the client computer issuing an updating command to the network storage apparatus via the network, the method comprising the steps of:
performing an initialization procedure on an updating system,
receiving a code file from the server computer and an updating command from the client computer via the network;
selecting a control mode according to the updating command, wherein the control mode comprises at least one of a writing mode, an erasing mode, a correction mode, and the combinations thereof; and
transmitting a clock signal to a controller of the updating system via a clock channel and simultaneously transmitting the code file to the controller via a data channel based on the clock signal for updating the original codes in the controller while the updating system receives the updating command during the writing mode.

19. The method of claim 18, during the erasing mode, further comprising a step of erasing the original codes in the controller based on the updating command.

20. The method of claim 18, during the correction mode, further comprising a step of calculating a checksum value of the code file in the controller based on the updating command for checking the correction of the code file.
